(19) United States
(12) Patent Application Publication
(10) Pub. No.: US 2024/0031878 A1
(43) Pub. Date: Jan. 25, 2024

(54) DEVICES AND METHODS FOR UE APPLICATION CONTEXT RELOCATION IN AN EDGE NETWORK

(71) Applicant: HUAWEI TECHNOLOGIES CO., LTD., Shenzhen, Guangdong (CN)

(72) Inventors: Roya REZAGAH, Munich (DE); Qi YAO, Beijing (CN); Niranth AMOGH, Munich (DE)

(73) Assignee: HUAWEI TECHNOLOGIES CO., LTD., Shenzhen, Guangdong, GD (CN)

(21) Appl. No.: 18/477,733

(22) Filed: Sep. 29, 2023

Related U.S. Application Data
(63) Continuation of application No. PCT/CN2021/085129, filed on Apr. 1, 2021.

(51) Int. Cl. H04W 36/00; H04W 36/32; H04W 8/12; H04W 4/029

(52) U.S. Cl. CPC H04W 36/0033; H04W 36/32; H04W 8/12; H04W 4/029

(57) ABSTRACT

Embodiments of a target edge application server (T-EAS) and a related method for supporting an application context relocation (ACR) procedure of user equipment (UE) in a communication network are disclosed. In response to a predicted movement of the UE from a current location to a predicted location within a coverage region of the T-EAS, the T-EAS is configured to receive, in an ACR execution phase of the ACR procedure, an application context of the UE from a source edge application server (S-EAS). Moreover, in response to obtaining information that the UE is no longer expected to move to the predicted location within the coverage region of the T-EAS, the T-EAS is further configured to perform, in a post-ACR clean-up phase of the ACR procedure, at least one post-ACR clean-up operation which at least includes discarding the application context.

### CROSS-REFERENCE TO RELATED APPLICATIONS

This application is a continuation of International Application No. PCT/CN2021/085129 filed on Apr. 1, 2021, the disclosure of which is hereby incorporated by reference in its entirety.

### TECHNICAL FIELD

The present disclosure generally relates to communications networks, and more specifically, the present disclosure relates to devices and methods for an application context relocation of user equipment (UE) in an edge network.

### BACKGROUND

Generally, an edge application server (EAS), which is in communication with an application client (AC) of user equipment (UE), is associated with an application context of the UE. To provide service continuity, the application context from a source EAS (S-EAS) is transferred to a target edge application server (T-EAS) when the UE moves to a new location within the coverage region of the T-EAS. This procedure is referred to as application context transfer (ACT). ACT is generally part of an application context relocation (ACR) procedure that may include further steps and involve additional network entities. Depending on the network entity that initiates or executes the ACR, different ACR procedures have been proposed for different ACR scenarios. Some examples include an initiation of the ACR procedure by an edge enabling client (EEC) of the UE using a regular EAS discovery, an EEC executed ACR via a source edge enabling server (S-EES), a S-EAS decided ACR procedure, a S-EES executed ACR procedure, and an EEC executed ACR procedure via a target edge enabling server (T-EES).

It has been proposed within the framework of a third generation partnership project (3GPP) system to use these ACR procedures for planning the service continuity for a user based on predicting a future location UE is expected to move to. More specifically, the application context transfer can be performed to a predicted future location. In other words, the application context can be transferred in advance from the S-EAS to a T-EAS, so that it may provide superior service continuity for the UE when the UE moves to the predicted future location. In all of these ACR procedures, which may comprise an ACR detection phase, an ACR decision phase, an ACR execution phase, and a post-ACR clean up phase, there are one or more processing steps that depend on an actual presence of the UE at the predicted future location. For instance, in an ACR procedure initiated by the EEC of the UE using regular EAS discovery the clean up is performed after the UE has moved to the predicted future location.

In conventional technologies, it has been problematic when the UE does not actually move to the predicted future location. For instance, there are scenarios where the UE might change its trajectory at a moment. An example scenario could be UE in a car or vehicular UE with a high velocity. In these examples, it is beneficial to use the predicted future location to better plan for service continuity. However, the UE might change its route or may stop spontaneously. In these cases, after the ACT has been performed, the UE remains connected to the S-EAS, and does not connect to the T-EAS. However, the application context still exists in both S-EAS and T-EAS and the T-EAS waits endlessly for the UE to move to the future predicted location.

In another instance, in an ACR procedure initiated by the EEC of the UE using regular EAS discovery the ACR steps (such as ACT clean up) are performed after the UE has moved to the predicted future location without considering the service continuity planning that was previously initiated for the predicted future location. This will also be problematic as the already established ACR state (such as T-EAS discovery, ACT performed) is not considered in order to reduce the time to complete the ACR process.

The UE location information may be obtained, for example, by the UE itself or via the location application programming interfaces (APIs) provided by the 3GPP system (e.g., service capabilities exposure function (SCEF), network exposure function (NEF), location services (LCS), seal enabler architecture layer (SEAL) LMS).

### SUMMARY

Embodiments of the present disclosure provide for devices and methods for an improved application context relocation of user equipment (UE) in an edge network.

The foregoing and other objectives are achieved by the subject matter of the independent claims. Further implementations of the subject matter are apparent from the dependent claims, the description and the figures.

According to a first aspect, a target edge application server (T-EAS) for supporting an application context relocation (ACR) procedure of user equipment (UE) in a communication network is provided. The T-EAS is configured to receive, in an ACR execution phase, an application context of the UE from a source edge application server (S-EAS) of the communication network. The T-EAS receives this application context of the UE due to a predicted movement of the UE from a current location to a predicted location within a coverage region of the T-EAS. In response to obtaining information that the UE is no longer expected (e.g., predicted) to move to the predicted location within the coverage region of the T-EAS, the T-EAS is further configured to perform, in a post-ACR clean-up phase, at least one post-ACR clean-up operation. Thus, advantageously, the T-EAS is informed or understands that the UE will very likely not be moving to a predicted future location so that the T-EAS may take the appropriate actions, such as discarding the application context which relieves resources of the T-EAS.

In a further possible implementation form of the first aspect, the T-EAS is configured to obtain the information that the UE is no longer expected to move to the predicted location within the coverage region of the T-EAS by determining that an ACR expiration time or an ACR validity time interval for the application context of the UE has expired.

In a further possible implementation form of the first aspect, the T-EAS is configured to receive the ACR expiration time or the ACR validity time interval for the application context of the UE from a network entity of the communication network.

In a further possible implementation form of the first aspect, the T-EAS is configured to receive the ACR expiration time or the ACR validity time interval for the application context of the UE from the network entity that initiated the ACR procedure and/or from the network entity that determined the predicted location of the UE within the coverage region of the T-EAS. As used herein, initiating the ACR procedure may comprise triggering, deciding, and/or executing the ACR procedure.

In a further possible implementation form of the first aspect, the T-EAS is configured to receive the ACR expiration time or the ACR validity time interval for the application context of the UE from the UE.

In a further possible implementation form of the first aspect, the ACR expiration time or ACR validity time interval is based on at least one of a velocity of the UE, a movement direction of the UE, a movement pattern of the UE, a route of the UE, or a motion prediction accuracy of the UE.

In a further possible implementation form of the first aspect, the T-EAS is configured to obtain the information that the UE is no longer expected to move to the predicted location within the coverage region of the T-EAS by receiving a message from a network entity of the communication network indicating that the UE is no longer expected to move to the predicted location within the coverage region of the T-EAS.

In a further possible implementation form of the first aspect, the T-EAS is configured to receive the message indicating that the UE is no longer expected to move to the predicted location within the coverage region of the T-EAS from the network entity that initiated the ACR procedure and/or that determined the predicted location of the UE within the coverage region of the T-EAS. As used herein, initiating the ACR procedure may comprise triggering, deciding, and/or executing the ACR procedure.

In a further possible implementation form of the first aspect, the T-EAS is configured to receive the message indicating that the UE is no longer expected to move to the predicted location within the coverage region of the T-EAS from the UE, the S-EAS, a source edge enable server (S-EES) or a target edge enabler server (T-EES) of the communication network.

In a further possible implementation form of the first aspect, the T-EAS is configured to, in response to obtaining the information that the UE is no longer expected to move to the predicted location within the coverage region of the T-EAS, discard the application context of the UE for performing, in the post-ACR clean-up phase, the at least one post-ACR clean-up operation.

In a further possible implementation form of the first aspect, the T-EAS is configured to store, in the ACR execution phase, the application context in a memory of the T-EAS.

According to a second aspect a method of operating a T-EAS for an ACR procedure of UE in a communication network is provided. The method comprises the following steps implemented by the T-EAS:

Receiving in an ACR execution phase of the ACR procedure, an application context of the UE from a S-EAS of the communication network due to a predicted movement of the UE from a current location to a predicted location within a coverage region of the T-EAS; and

In response to obtaining information that the UE is no longer expected to move to the predicted location within the coverage region of the T-EAS, performing, in a post-ACR clean-up phase of the ACR procedure, at least one post-ACR clean-up operation.

The method according to the second aspect of the present disclosure can be performed by the T-EAS according to the first aspect of the present disclosure. Thus, further features of the method according to the second aspect of the present disclosure directly result from the functionality of the T-EAS according to the first aspect of the present disclosure and its different implementation forms described above and below.

According to a third aspect a network entity for supporting an ACR procedure of UE in a communication network is provided. The network entity is configured to generate, or in other words, determine an ACR expiration time or an ACR validity time interval for an application context of the UE. Due to a predicted movement of the UE from a current location within a coverage region of a S-EAS of the communication network to a predicted location within a coverage region of a T-EAS of the communication network, the application context of the UE is transferred from the S-EAS to the T-EAS. The network entity is further configured to provide the ACR expiration time or the ACR validity time interval to the T-EAS or to a T-EES of the communication network associated with the T-EAS.

In a further possible implementation form of the third aspect, the network entity is further configured to initiate the ACR procedure. As used herein, initiating the ACR procedure may comprise triggering, deciding, and/or executing the ACR procedure.

In a further possible implementation form of the third aspect, the network entity is further configured to determine the predicted location of the UE.

In a further possible implementation form of the third aspect, the network entity is the UE, a S-EES, or the S-EAS of the communication network.

In a further possible implementation form of the third aspect, the network entity is configured to generate the ACR expiration time or the ACR validity time interval for the application context of the UE based on at least one of a velocity of the UE, a movement direction of the UE, a movement pattern of the UE, a route of the UE, or a motion prediction accuracy of the UE.

According to a fourth aspect a method of operating a network entity for supporting an ACR, procedure of UE in a communication network is provided. The method comprises the steps of:

Generating, or in other words, determining an ACR expiration time or an ACR validity time interval for an application context of the UE. Due to a predicted movement of the UE from a current location within a coverage region of a S-EAS of the communication network to a predicted location within a coverage region of a T-EAS of the communication network, the application context of the UE is transferred from the S-EAS to the T-EAS; and

Providing the ACR expiration time or the ACR validity time interval to the T-EAS or a T-EES of the communication network associated with the T-EAS for monitoring the ACR expiration time or the ACR validity time interval for the T-EAS.

The method according to the fourth aspect of the present disclosure can be performed by the network entity according to the third aspect of the present disclosure. Thus, further features of the method according to the fourth aspect of the present disclosure directly result from the functionality of the network entity according to the third aspect of the present disclosure and its different implementation forms described above and below.

According to a fifth aspect, a network entity for supporting an ACR procedure of UE in a communication network is provided. Due to a predicted movement of the UE from a current location within a coverage region of a S-EAS of the communication network to a predicted location within a coverage region of a T-EAS of the communication network, the application context of the UE is transferred from the S-EAS to the T-EAS. The network entity is configured to determine that the UE is no longer expected to move to the predicted location within the coverage region of the T-EAS. The network entity may determine this via the location information from the UE itself or the location application programming interfaces (APIs) provided by a third generation partnership project (3GPP) system (e.g., service capabilities exposure function (SCEF), network exposure function (NEF), location services (LCS), seal enabler architecture layer (SEAL) LMS). Moreover, the network entity is configured to provide information to the T-EAS and/or a T-EES of the communication network associated with the T-EAS, that the UE is no longer expected to move to the predicted location within the coverage region of the T-EAS.

In a further possible implementation form of the fifth aspect, the network entity is further configured to initiate the ACR procedure. As used herein, initiating the ACR procedure may comprise triggering, deciding, and/or executing the ACR procedure.

In a further possible implementation form of the fifth aspect, the network entity is further configured to determine the predicted location of the UE.

In a further possible implementation form of the fifth aspect, the network entity is the UE, a S-EES, or the S-EAS of the communication network.

According to a sixth aspect, a method of operating a network entity for supporting an ACR procedure of UE in a communication network is provided. Due to a predicted movement of the UE from a current location within a coverage region of a S-EAS of the communication network to a predicted location within a coverage region of a T-EAS of the communication network, the application context of the UE is transferred from the S-EAS to the T-EAS. The method comprises the steps of:

Determining that the UE is no longer expected to move to the predicted location within the coverage region of the T-EAS. This determination may include considering the location information from the UE itself or the location APIs provided by a 3GPP system (e.g., SCEF, NEF, LCS, SEAL LMS); and

Providing the information to the T-EAS and/or a T-EES of the communication network associated with the T-EAS, that the UE is no longer expected to move to the predicted location within the coverage region of the T-EAS.

The method according to the sixth aspect of the present disclosure can be performed by the network entity according to the fifth aspect of the present disclosure. Thus, further features of the method according to the sixth aspect of the present disclosure directly result from the functionality of the network entity according to the fifth aspect of the present disclosure and its different implementation forms described above and below.

According to a seventh aspect, a computer program or a computer program product is provided, which comprises a computer-readable storage medium carrying program code which causes a computer or a processor to perform the method according to the second aspect, the method according to the fourth aspect, or the method according to the sixth aspect when the program code is executed by the computer or the processor.

According to an eighth aspect, a network entity for supporting an ACR, procedure of UE in a communication network is provided. The network entity is configured to send, during an ACR execution phase of the ACR procedure, an initial portion of an application context of the UE to a T-EAS of the communication network. The initial portion may include static aspects of the application context of the UE which do not change frequently. The network entity sends the initial portion in response to a predicted movement of the UE from a current location to a predicted location within a coverage region of the T-EAS. Moreover, in response to obtaining information that the UE has moved to the predicted location within the coverage region of the T-EAS, e.g. by the UE itself or via the location APIs provided by a 3GPP system (e.g., SCEF, NEF, LCS, SEAL LMS), the network entity is further configured to send during the ACR execution phase of the ACR procedure one or more final remaining portions of the application context of the UE to the T-EAS. The one or more final remaining portions of the application context of the UE include dynamic aspects which are parts of the application context that change very frequently. Advantageously, the network entity according to the eighth aspect allows an acceleration of the ACR procedure by considering the ACR state established by the previously initiated service continuity planning.

In a further possible implementation form of the eighth aspect, the network entity is further configured to initiate the ACR procedure. As used herein, initiating the ACR procedure may comprise triggering, deciding, and/or executing the ACR procedure.

In a further possible implementation form of the eighth aspect, the network entity is further configured to determine the predicted location of the UE.

In a further possible implementation form of the eighth aspect, the network entity is further configured to determine that the UE has moved to the predicted location within the coverage region of the T-EAS.

In a further possible implementation form of the eighth aspect, the network entity is further configured to partition the application context. In other words, the network entity generates the initial portion of the application context and the one or more remaining portions of the application context. In a further implementation form, the partitioning of the application context may be predefined, or it may be determined by signaling between the network entity and the T-EAS.

This signaling between the network entity and the T-EAS may be configured to determine what the suitable partition sizes should be and to consider transferring the portions of application context (e.g., via request-response or subscribe-notify mechanisms). These determination regarding the portions may be dependent on the application itself and may be predefined.

The different aspects of the present disclosure can be implemented in software and/or hardware.

Details of one or more embodiments are set forth in the accompanying drawings and the description below. Other features, objects, and advantages will be apparent from the description, drawings, and claims.

### BRIEF DESCRIPTION OF THE DRAWINGS

These and other features of the present disclosure will become readily apparent upon further review of the following specification and drawings. In the drawings, like reference numerals designate corresponding parts throughout the views. Moreover, components in the drawings are not necessarily drawn to scale, the emphasis instead being placed upon clearly illustrating the principles of the present disclosure.

In the following, embodiments of the present disclosure are described in more detail with reference to the attached figures and drawings, in which:

FIG. 1 is a schematic diagram illustrating a communication network with an architecture for enabling edge applications;

FIG. 2 is a schematic diagram illustrating more details of the communication network of FIG. 1 for implementing an application context relocation (ACR) procedure, including a target edge application server (T-EAS) according to an embodiment;

FIG. 3 is a flow diagram illustrating different phases of a general ACR procedure;

FIG. 4 is a flow diagram illustrating further details of an ACR procedure according to an embodiment;

FIG. 5 is a flow diagram illustrating further details of an ACR procedure according to a further embodiment;

FIG. 6 is a flow diagram illustrating a method for supporting an ACR procedure by a T-EAS of the communication network of FIG. 2 according to an embodiment;

FIG. 7 is a flow diagram illustrating a method for supporting an ACR procedure by a network entity of the communication network of FIG. 2 according to an embodiment;

FIG. 8 is a flow diagram illustrating a method for supporting an ACR procedure by a network entity of the communication network of FIG. 2 according to a further embodiment;

FIG. 9 is a flow diagram illustrating further details of an ACR procedure according to a further embodiment;

FIG. 10 is a flow diagram illustrating further details of an ACR procedure according to a further embodiment; and

FIG. 11 is a flow diagram illustrating further details of an ACR procedure according to a further embodiment.

In the following identical reference signs refer to identical or at least functionally equivalent features.

### DETAILED DESCRIPTION

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is to be understood that a disclosure in connection with a described method may also hold true for a corresponding device or system configured to perform the method and vice versa. For example, if one or a plurality of specific method steps are described, a corresponding device may include one or a plurality of units (e.g., circuits) to perform the described one or plurality of method steps (e.g., one unit performing the one or plurality of steps or a plurality of units each performing one or more of the plurality of steps), even if such one or more units are not explicitly described or illustrated in the figures. On the other hand, for example, if a specific apparatus is described based on one or a plurality of units (e.g., functional circuit), a corresponding method may include one step to perform the functionality of the one or plurality of units (e.g., one step performing the functionality of the one or plurality of units or a plurality of steps each performing the functionality of one or more of the plurality of units), even if such one or plurality of steps are not explicitly described or illustrated in the figures. Further, it is understood that the features of the various embodiments and/or aspects described herein may be combined with each other, unless specifically noted otherwise.

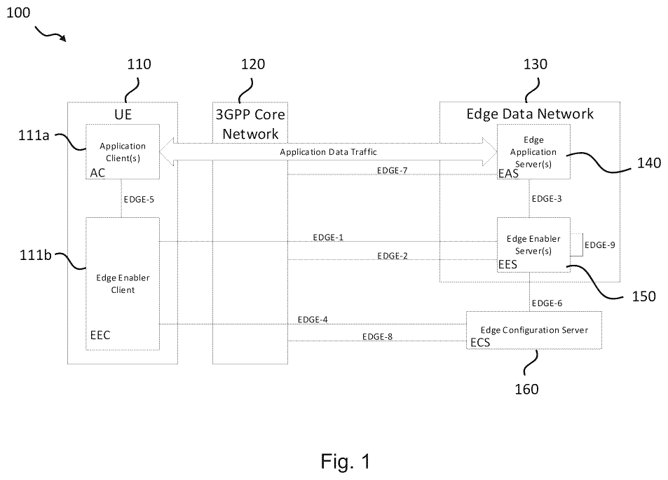

FIG. 1 is a schematic diagram illustrating a communication network 100 with an architecture for enabling edge applications (EDGEAPP) as described in the specification 3GPP technical specification (TS) 23.558, which is fully enclosed herein by reference. The communication network 100 comprises UE 110 configured to communicate via a 3GPP core network 120 with an edge data network 130 with a plurality of edge application servers (EAS) 140 and a plurality of edge enabler servers (EES) 150. As illustrated in FIG. 1, in an embodiment, the UE 110 may comprise one or more application clients (ACs) 111a and an edge enabler client 111b. The one or more ACs 111a of the UE 111a are configured to communicate via the 3GPP core network 120 with the plurality of edge application servers 140 and the edge enabler client 111b of the UE 111a is configured to communicate via the 3GPP core network 120 with the plurality of edge enabler servers (EES) 150. As further illustrated in FIG. 1, the edge enabler client 111b of the UE 111a may be further configured to communicate via the 3GPP core network 120 with an edge configuration server (ECS) 160. The ECS 160 may be configured to control the plurality of EES 150.

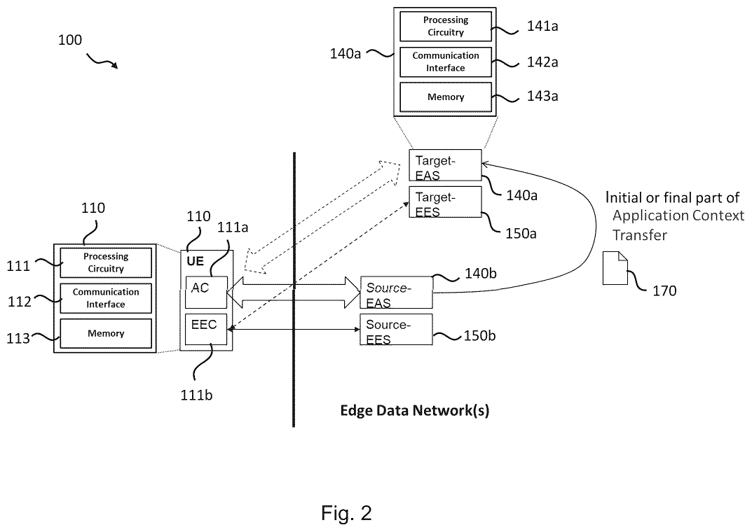

As will be described in more detail with further reference to FIG. 2, the communication network 100 and the elements thereof are configured to perform an application context relocation (ACR) procedure involving a transfer of an application content 170 from one of the plurality of edge application servers 140 (referred to as source edge application server (S-EAS) 140b) to another one of the plurality of edge application servers 140 (referred to as target edge application server (T-EAS) 140a). The S-EAS 140b may be associated with one of the plurality of edge enabler servers 150 (referred to as source edge enabler server (S-EES) 150b), while the T-EAS 140a is associated with another one of the plurality of edge enabler servers 150 (referred to as target edge enabler server (T-EES) 150a).

As illustrated in FIG. 2, in an embodiment, the UE 110 may comprise a processing circuitry 111, for instance, a processor 111 for processing data and implementing, such as the AC 111a and the EEC 11b. The processing entity 111 may be implemented by hardware and/or software. The hardware may comprise digital circuitry or both analog and digital circuitry. Digital circuitry may comprise components such as application-specific integrated circuits (ASICs), field-programmable arrays (FPGAs), digital signal processors (DSPs), or general-purpose processors. The UE 110 may further comprise a communication interface 112 for transmitting and receiving data via 3GPP core network 120. In an embodiment, the communication interface 112 may comprise one or more antennas for wireless communication with one or more base stations. The UE 110 may further comprise a memory 113, such as a Flash memory 113, that is configured to store executable program code which, when executed by the processing entity 111, causes the UE 110 to perform the functions and operations described herein.

Likewise, the T-EAS 140a may comprise a processing circuitry 141a, for example, a processor 111 for processing data. The processing entity 141a may be implemented by hardware and/or software. The hardware may comprise digital circuitry or both analog and digital circuitry. Digital circuitry may comprise components such as ASICs, FPGAs, DSPs, or general-purpose processors. The T-EAS 140a may further comprise a communication interface 142a for transmitting and receiving data. The T-EAS 140a may further comprise a memory 143a, for example a Flash memory 143a, configured to store executable program code which, when executed by the processing entity 141a, causes the T-EAS 140a to perform the functions and operations described herein. In an embodiment, the memory 143a of the T-EAS 140a is configured to store the application context of the UE 110.

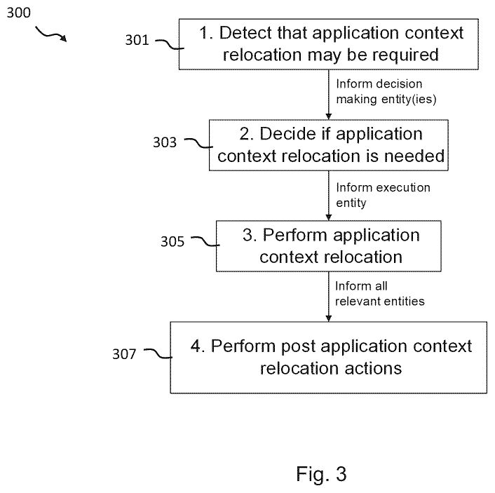

As disclosed above, the T-EAS 140a and the other network entities of the communication network 100 are configured to perform an ACR, procedure involving the transfer of the application context 170 from the S-EAS 140b to the T-EAS 140a. FIG. 3 is a flow diagram illustrating different phases of a ACR procedure 300 supported by the T-EAS 140a and the other network entities of the communication network 100 according to an embodiment. In a first phase I 301 of the ACR procedure 300, one of the network entities of the communication network 100 detects that a relocation of the application context 170 of the UE 110 may be required. In an embodiment, this may be detected by the UE 110 itself. In a second phase II 303 of the ACR procedure 300, one of the network entities of the communication network 100 determines whether an ACR is actually required. In an embodiment, this may be determined by the UE 110 itself. In a third phase III 305 of the ACR procedure 300, the actual ACR is performed which includes the transfer of the application context 170 from the S-EAS 140b to the T-EAS 140a. In a fourth final phase IV 307 of the ACR procedure 300, one or more of the network entities of the communication network 100, including the UE 110 and the T-EAS 140a may perform a post-ACR clean up.

Thus, the T-EAS 140a is configured to support the ACR procedure 300 of the UE 110 in the communication network 100. To this end, the T-EAS 140a is configured to receive in the ACR execution phase III 305 of the application procedure 300, an application context 170 of the UE 110 from the S-EAS 140b due to a predicted movement of the UE 110 from a current location to a predicted location within a coverage region of the T-EAS 140a. In an embodiment, the transfer of the application context 170 from the S-EAS 140b to the T-EAS 140a may comprise the transfer of at least two parts or portions of the application context 170 to the T-EAS 140a. In other words, in an embodiment, due to a predicted movement of the UE 110 from a current location to a predicted location within a coverage region of the T-EAS 140a the T-EAS 140a is configured to initially receive in the ACR execution phase III 305 of the application procedure 300, a first portion of the application context 170 and, thereafter, to receive one or more remaining final portions of the application context 170. In response to obtaining information that the UE 110 has not or is no longer expected to move to the predicted location within the coverage region of the T-EAS 140a, the T-EAS 140a is further configured to perform in the post-ACR clean-up phase IV 307 of the ACR procedure, at least one post-ACR clean-up operation (based on the information that the UE 110 has not or is no longer expected to move to the predicted location within the coverage region of the T-EAS 140a).

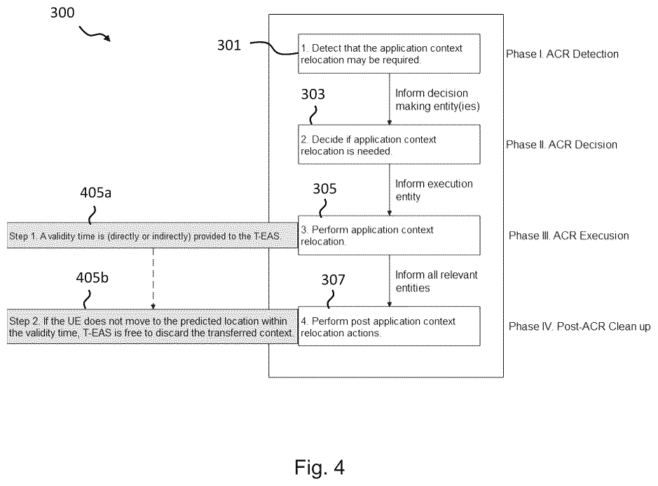

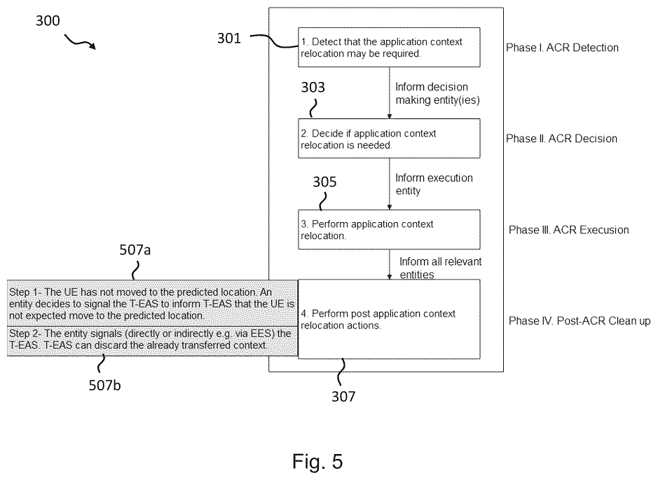

Further embodiments of the ACR procedure 300 of the UE 110 as supported by the T-EAS 140a are illustrated in FIGS. 4 and 5.

In the embodiment shown in FIG. 4, the ACR execution phase III 305 of the application procedure 300 further comprises one or more steps 405a, which provide an ACR expiration time and/or an ACR validity time interval of the application context 170 to the T-EAS 140a. In an embodiment, the ACR expiration time may define a set point in time (such as 09:00), while the ACR validity time interval defines a time interval (such as 1 minute). In an embodiment, the ACR expiration time or the ACR validity time interval of the application context 170 may be generated and provided to the T-EAS 140a by one or more of the other network entities of the communication network 100. In an embodiment, the ACR expiration time or the ACR validity time interval of the application context 170 may be generated and/or provided to the T-EAS 140a by the network entity that initiated the ACR procedure 300. In an embodiment, the expiration time or the validity time interval of the application context 170 may be generated and/or provided to the T-EAS 140a by the network entity that predicted the location of the UE 110 within the coverage region of the T-EAS 140a. As used herein, initiating the ACR procedure may comprise triggering, deciding, and/or executing the ACR procedure. In an embodiment, the ACR expiration time or the ACR validity time interval of the application context 170 may be generated and/or provided to the T-EAS 140a by the UE 110 itself, the S-EES 150b, or the S-EAS 140b of the communication network 100. In an embodiment, the value of the ACR expiration time or the ACR validity time interval for the application context 170 of the UE 110 may be based on at least one of a velocity of the UE 110, a movement direction of the UE 110, a movement pattern of the UE 110, a route of the UE 110, or a motion prediction accuracy of the UE 110. For instance, for a fast moving UE 110, the ACR validity time interval may be relatively short.

In an embodiment, the ACR expiration time or the ACR validity time interval may be provided to the T-EAS 140a alongside (e.g., provided simultaneously, provided before, or provided after) the transfer of the application context 170.

In a further embodiment, the ACR expiration time or ACR validity time interval of the application context 170 may be provided to a network entity of the communication network 100 that is configured to inform the T-EAS 140a about the expiry of the ACR expiration time or the ACR validity time interval of the application context 170. Thus, if the UE 110 does not move to the predicted location by the ACR expiration time or within the ACR validity time interval, the network entity may signal this event to the T-EAS 140a.

As illustrated in FIG. 4, the post-ACR clean up phase III 307 of the application procedure 300 further comprises one or more post-ACR clean-up operations when the UE 110 has not moved or is no longer expected to move to the predicted location within the coverage region of the T-EAS 140a. In an embodiment, the T-EAS 140a is configured to, in response to determining that by the ACR expiration time or within the ACR validity time that the UE 110 has not moved to the predicted location within the coverage region of the T-EAS 140a, to discard the application context 170 of the UE 110 for performing the at least one post-ACR clean-up operation. In an embodiment, the T-EAS 140a may remove the application context 170 from its memory 143a.

In the embodiment shown in FIG. 5, the post-ACR clean up phase III 307 of the application procedure 300 further comprises a first step 507a, where one or more of the network entities of the communication network 100 determine that the UE 110 is no longer expected to move to the predicted target location within the coverage region of the T-EAS 140a. This may be determined by utilizing the location information from the UE 110 itself or the location APIs provided by the 3GPP system (e.g., service capabilities exposure function (SCEF), network exposure function (NEF), location services (LCS), seal enabler architecture layer (SEAL) LMS). In a further step 507b the network entity is configured to signal this information to the T-EAS 140a, which, in response thereto, may discard the application context 170 of the UE 110. In an embodiment, this information may be signaled to the T-EES 150a, which is configured to forward this information to the T-EAS 140a. In an embodiment, the network entity signaling this information to the T-EAS 140a (or the T-EES 150a) may be the UE 110 (e.g. via the S-EAS 140b). In an embodiment, the network entity signaling this information to the T-EAS 140a may be the network entity that initiated the ACR procedure 300, such as the UE 110, the S-EES 150b, the T-EES 150a or the S-EAS 140b. In an embodiment, the network entity signaling this information to the T-EAS 140a may be the network entity that provided the location predication, such as the UE 110, the S-EES 150b, the T-EES 150a or the S-EAS 140b. In an embodiment, the network entity may signal this information to the T-EAS 140a (or the T-EES 150a) based on own measurements or observations about the movement of the UE 110. In an embodiment, the network entity may signal this information to the T-EAS 140a (or the T-EES 150a) based on an update of the predicted location of the UE 110 (whether predicted by itself or by another network entity of the communication network 100).

As will be appreciated, embodiments disclosed herein resolve the issue concerning the application context transfer for a predicted future location of the UE 110 in EDGEAPP. Embodiments disclosed herein provide procedures for informing the T-EAS 140a that it can terminate the ACR and discard the transferred application context 170. Thus, resources of the T-EAS 140a may be used more efficiently.

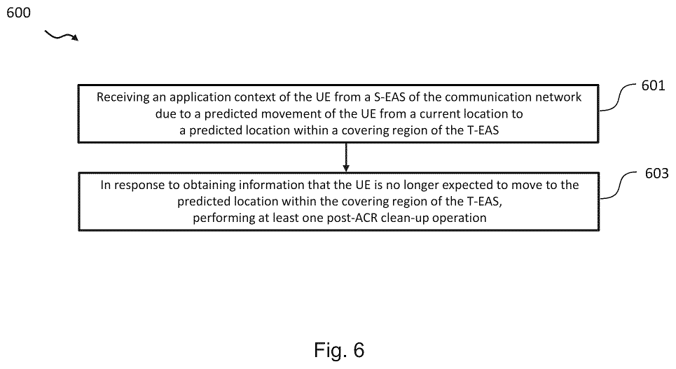

FIG. 6 is a flow diagram illustrating a method 600 of operating the T-EAS 140a for the ACR procedure 300 of the UE 110 in the communication network 100. The method 600 comprises the following steps that are implemented by the T-EAS 140a. The T-EAS 140a receives 601 an application context 170 of the UE 110 from the S-EAS 140b of the communication network 100 due to a predicted movement of the UE 110 from a current location to a predicted location within a coverage region of the T-EAS 140a. In response to obtaining information that the UE 110 is no longer expected to move to the predicted location within the coverage region of the T-EAS 140a, the T-EAS 140a performs 603 at least one ACR procedure clean-up operation. In an embodiment, the step 603 of performing the at least one ACR procedure clean-up operation comprises discarding the application context 170 of the UE 110, which, in an embodiment, may be stored in the memory 143a of the T-EAS 140a.

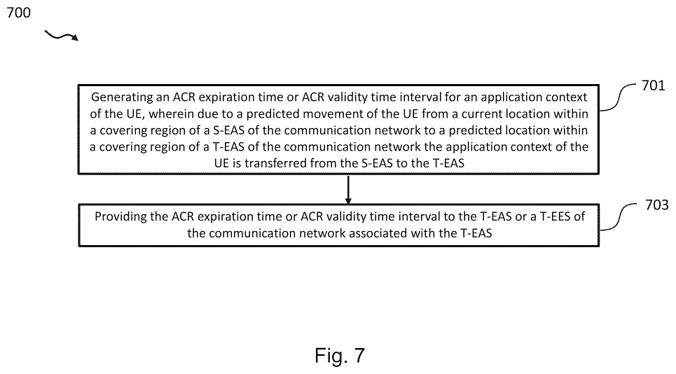

FIG. 7 is a flow diagram that illustrates a method 700 of operating a network entity of the communication network 100. The network entity of the communication network 100 supports the ACR procedure 300 of the UE 110 that is illustrated in FIG. 4 in the communication network 100. In an embodiment, the network entity may be the UE 110 itself, the S-EES 150b, or the S-EAS 140b of the communication network 100. The method 700 comprises a first step 701 of generating an ACR expiration time or an ACR validity time interval for the application context 170 of the UE 110. Due to a predicted movement of the UE 110 from a current location within the coverage region of the S-EAS 140b to a predicted location within the coverage region of the T-EAS 140a, the application context 170 of the UE 110 is transferred from the S-EAS 140b to the T-EAS 140a. The method 700 further comprises step 703 of providing, or in other words, transmitting the ACR expiration time or the ACR validity time interval to the T-EAS 140a or the T-EES 150a associated with the T-EAS 140a.

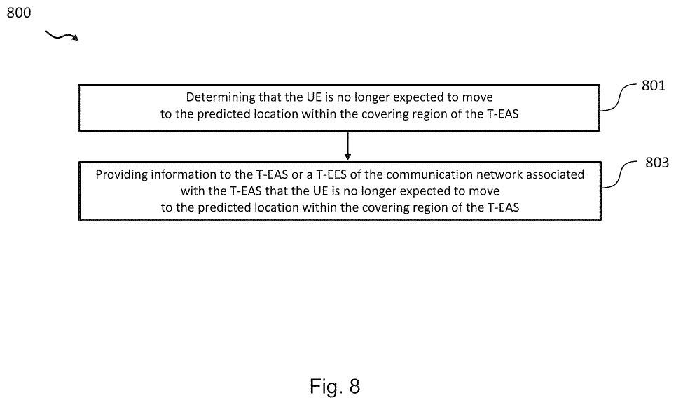

FIG. 8 is a flow diagram illustrating a method 800 of operating a network entity for supporting the ACR procedure 300 of the UE 110 illustrated in FIG. 5 in the communication network 100. In an embodiment, the network entity is the UE 110 itself, the S-EES 150b, or the S-EAS 150a of the communication network 100. As already described above, due to a predicted movement of the UE 110 from a current location within the coverage region of the S-EAS 140b to a predicted location within the coverage region of the T-EAS 140a, the application context 170 of the UE 110 is transferred from the S-EAS 140b to the T-EAS 140a. The method 800 comprises a first step 801 of determining, by the network entity, that the UE 100 is no longer expected to move to the predicted location within the coverage region of the T-EAS. Furthermore, the method 800 comprises a step 803 of providing information from the network entity to the T-EAS 140a and/or the T-EES 150a that is associated with the T-EAS 140a. The provided information includes that the UE 110 is no longer expected to move to the predicted location within the coverage region of the T-EAS 140a.

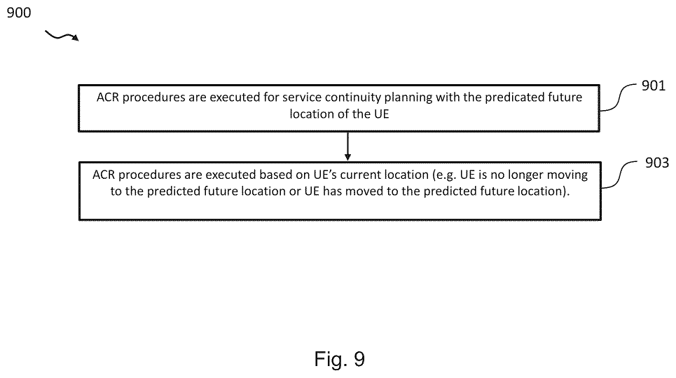

Further embodiments of the ACR procedure 300 of the UE 110 as supported by the T-EAS 140a and/or one or more of the other network entities of the communication network 100 are illustrated in FIGS. 9, 10 and 11.

In the embodiment shown in FIG. 9, the overall service continuity method 900 requires that the ACR procedures are performed at least twice. In the first step 901 of the method 900, the ACR procedures are executed due to a planned service continuity based on a predicted future location of the UE 110. The first step 901 is followed by at least a second step 902 of the method 900, where the ACR procedures are executed relative to UE's current location (e.g., the UE 110 is no longer moving to the predicted future location or the UE 110 has moved to the predicted future location).

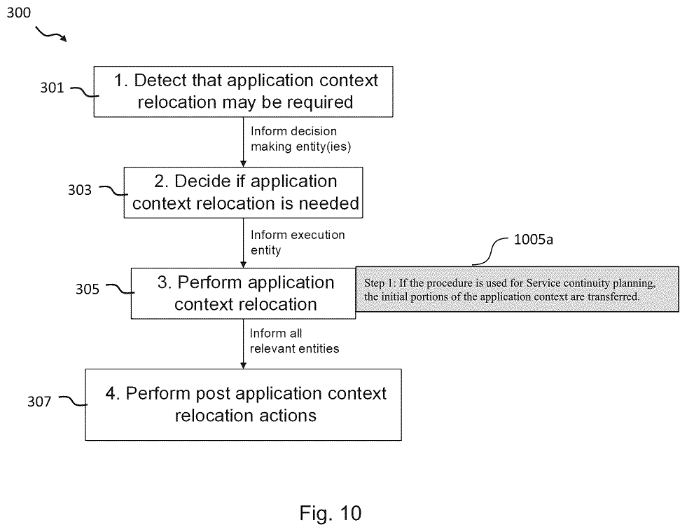

In the embodiment shown in FIG. 10, the ACR execution phase III 305 of the application procedure 300 further comprises one or more steps 1005a, which transfer an initial part or portion of the application context 170 to the T-EAS 140a. In an embodiment, the initial portion of the application context 170 may be specific to a point in time. In an embodiment, the initial portion of the application context 170 may be provided to the T-EAS 140a by one or more of the other network entities of the communication network 100. In an embodiment, the initial portion of the application context 170 may be provided to the T-EAS 140a by the network entity that initiated the ACR procedure 300. In an embodiment, the initial portion of the application context 170 may be provided to the T-EAS 140a by the network entity that predicted the location of the UE 110 within the coverage region of the T-EAS 140a. In an embodiment, the initial portion of the application context 170 may be provided to the T-EAS 140a by the UE 110 itself, the S-EES 150b or the S-EAS 140b of the communication network 100. In an embodiment, the initial portion of the application context 170 of the UE 110 may be determined by at least the S-EAS 140b or by the S-EES 150b or it may be predefined or it may be determined by signaling between the S-EAS 140b and T-EAS 140a or it may be determined by signaling between the S-EES 150b and the T-EES 150a.

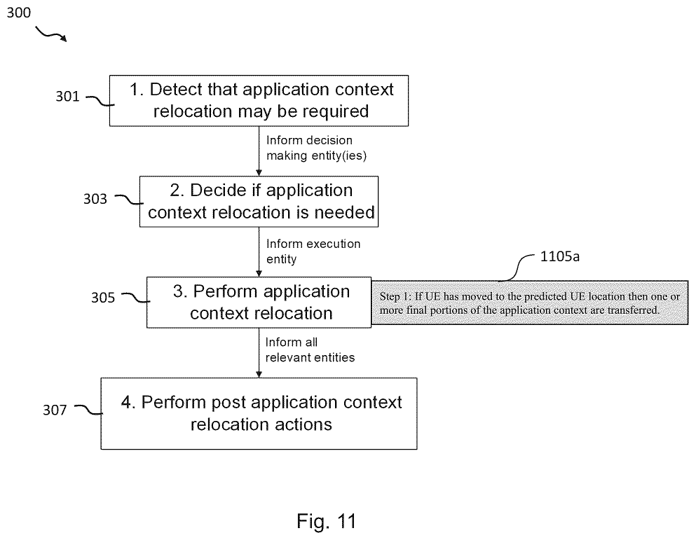

In the embodiment shown in FIG. 11, the ACR execution phase III 305 of the application procedure 300 further comprises one or more steps 1105a, which transfer one or more final remaining portions of the application context 170 to the T-EAS 140a, when the UE 110 moves to the predicted UE location. In an embodiment, the one or more final portions of the application context 170 may be specific to a point in time, when the UE 110 moves to the predicted UE location. In an embodiment, the one or more final portions of the application context 170 may be provided to the T-EAS 140a by one or more of the other network entities of the communication network 100. In an embodiment, the one or more final portions of the application context 170 may be provided to the T-EAS 140a by the network entity that initiated the ACR procedure 300. In an embodiment, the one or more final portions of the application context 170 may be provided to the T-EAS 140a by the network entity that predicted the location of the UE 110 within the coverage region of the T-EAS 140a. In an embodiment, the one or more final portions of the application context 170 may be provided to the T-EAS 140a by the UE 110 itself, the S-EES 150b, or the S-EAS 140b of the communication network 100. In an embodiment, the one or more final portions of the application context 170 of the UE 110 may be determined by at least the S-EAS 140b or may be determined by the S-EES 150b or it may be predefined or it may be determined by signaling between the S-EAS 140b and the T-EAS 140a, or it may be determined by signaling between the S-EES 150b and the T-EES 150a.

As will be appreciated, embodiments disclosed herein also resolve another issue in application context transfer for a predicted future location of the UE in EDGEAPP. The embodiments disclosed herein provide procedures that inform the S-EAS 140b that it can efficiently transfer the application context 170. Thus, resources of the communication network 100 may be used more efficiently and the time for performing the ACR execution phase III 305 of the application procedure 300 may be reduced.

Further embodiments disclose a method of operating a network entity for supporting the ACR procedure as follows:

When: an entity provides a prediction for one or more future location(s) (whether predicted by itself or it received the prediction or assistance in predicting from one or more other entities), and a predicted future location is used for application context transfer,

then the S-EAS or S-EES determines the initial (e.g., the static aspects that do not change frequently) and the final (e.g., the dynamic aspects that are changed very frequently) parts of application context to be transferred to the T-EAS or the T-EES and further transfers the initial parts of the application context to the T-EAS or the T-EES.

Optionally, after the ACT is initiated, as part of the Service Continuity Planning and before the UE moves to the predicated location within the validity/expiration time, the S-EAS or the S-EES can determine intermediate parts (e.g., of initial and/or final parts) of application context and further transfer those intermediate parts to the T-EAS or the T-EES.

When the UE moves to the predicted location within the validity/expiration time, the S-EAS or the S-EES determines the final parts of the application context to be transferred to the T-EAS or the T-EES and further transfers the final parts of the application context to the T-EAS or the T-EES.

Additionally, the application context is generated by the S-EAS and is either stored in itself or in a network based storage. When the network based storage is used, the application context is accessible to the S-EES. The determination of the parts (including the quantity of parts) for the application context can be configured at the S-EAS or the S-EES.

Further embodiments provide for a method for Service Continuity Planning. The Edge Enabler Layer may perform the ACR process as per the following steps:

ACR Detection
a. ACR is detected due to a new UE location, and other criterion . . . .
b. Service continuity planning may be detected due to availability of an expected UE location

ACR Decision
a. Based on the ACR detection (ACR Detection a), the Edge Enabler Layer decides to initiate a normal ACR process.
b. Based on the ACR detection (ACR Detection a) and when the actual UE location is different than the expected UE location, the Edge Enabler Layer decides to execute a normal ACR process and perform a clean up of the resources at the predicted UE location.
c. Based on the ACR detection of the expected UE location (ACR Detection b), the Edge Enabler Layer decide to initiate a Service Continuity Planning ACR.
d. Based on the ACR detection of the UE location (ACR Detection a) and when it is same as a previously expected UE location for which service continuity ACR has been executed, then selectively execute the ACR process.

ACR Execution
a. If initiating the normal ACR process (ACR Decision a) then,
   i. Discover T-EAS for the actual UE location;
   ii. Perform ACT; and
   iii. Perform AF traffic influence.
b. Else if the normal ACR process and an actual UE location are different than an expected UE location (ACR Decision b) then,
   i. Initiate clean up for expected UE location (Post-ACR Clean Up b);
   ii. Discover T-EAS for the actual UE location;
   iii. Perform ACT; and
   iv. Perform AF traffic influence.
c. Else if performing service continuity planning ACR (ACR Decision c) then,
   i. Discover T-EAS for the expected UE location;
   ii. Perform initial ACT (support different flavors of Application Context); and
   iii. May perform application function (AF) traffic influence (early network path optimization).
d. Else if performing a normal ACR process and performing service continuity planning ACR is already executed (ACR Decision d) then,
   i. Skip discover T-EAS;
   ii. Finalize the pending ACT towards the T-EAS; and
   iii. Perform the AF traffic influence, if not already performed.
e. Post-ACR Clean up—
   i. If one of ACR Execution steps a, b, d a is executed, perform normal clean up (previous actual location and present actual location).
   ii. If ACR Execution step c is executed, there is no clean up.
   iii. If ACR Execution b is executed, release the resources (remove Application Context) either by explicit signaling or via expiry timer (at the expected UE location).

A person skilled in the art will understand that the “blocks” (“units”) of the various figures (method and apparatus) represent or describe functionalities of embodiments of the present disclosure (rather than necessarily individual “circuits” in hardware or software) and thus equally describe functions or features of apparatus embodiments as well as method embodiments (unit=step).

In the several embodiments provided in the present application, it should be understood that the disclosed system, apparatus, and method may be implemented in other manners. For example, the described embodiment of an apparatus is merely an example. For example, the unit division is merely logical function division and may be another division in an actual implementation. For example, a plurality of units (e.g., circuits) or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments. In addition, functional units in the embodiments of the invention may be integrated into one processing unit (e.g., circuit), or each of the units (e.g., circuits, sub-circuits) may exist alone physically, or two or more units are integrated into one unit.

What is claimed is:

1. A target edge application server (T-EAS) for supporting an application context relocation (ACR) procedure of user equipment (UE) in a communication network, wherein the T-EAS is configured to:
receive an application context of the UE from a source edge application server (S-EAS) of the communication network due to a predicted movement of the UE from a current location to a predicted location within a coverage region of the T-EAS; and
in response to obtaining information that the UE is no longer expected to move to the predicted location within the coverage region of the T-EAS, perform at least one post-ACR clean-up operation.

2. The T-EAS of claim 1, wherein the T-EAS is configured to obtain the information that the UE is no longer expected to move to the predicted location within the coverage region of the T-EAS by determining that an ACR expiration time or an ACR validity time interval for the application context of the UE has expired.

3. The T-EAS of claim 2, wherein the T-EAS is configured to receive the ACR expiration time or the ACR validity time interval for the application context of the UE from a network entity of the communication network.

4. The T-EAS of claim 3, wherein the T-EAS is configured to receive the ACR expiration time or the ACR validity time interval for the application context of the UE from at least one of a network entity that initiated the ACR procedure or a network entity that determined the predicted location of the UE within the coverage region of the T-EAS.

5. The T-EAS of claim 3, wherein the T-EAS is configured to receive the ACR expiration time or the ACR validity time interval for the application context of the UE from the UE.

6. The T-EAS of claim 2, wherein the ACR expiration time or the ACR validity time interval is determined based on at least one of a velocity of the UE, a movement direction of the UE, a movement pattern of the UE, a route of the UE, or a motion prediction accuracy of the UE.

7. The T-EAS of claim 1, wherein the T-EAS is configured to obtain the information that the UE is no longer expected to move to the predicted location within the coverage region of the T-EAS by receiving a message from a network entity of the communication network indicating that the UE is no longer expected to move to the predicted location within the coverage region of the T-EAS.

8. The T-EAS of claim 7, wherein the T-EAS is configured to receive the message indicating that the UE is no longer expected to move to the predicted location within the coverage region of the T-EAS from at least one of a network entity that initiated the ACR procedure or a network entity that determined the predicted location of the UE within the coverage region of the T-EAS.

9. The T-EAS of claim 7, wherein the T-EAS is configured to receive the message indicating that the UE is no longer expected to move to the predicted location within the coverage region of the T-EAS from the UE, the S-EAS, a source edge enable server (S-EES), or a target edge enabler server (T-EES) of the communication network.

10. The T-EAS of claim 1, wherein the T-EAS is configured to:
in response to obtaining the information that the UE is no longer expected to move to the predicted location within the coverage region of the T-EAS, discard the application context of the UE for performing the at least one post-ACR clean-up operation.

11. The T-EAS of claim 1, wherein the T-EAS is configured to store the application context in a memory of the T-EAS.

12. A method of operating a target edge application server (T-EAS) for an application context relocation (ACR) procedure of user equipment (UE) in a communication network, wherein the method comprises the following steps implemented by the T-EAS:
receiving an application context of the UE from a source edge application server (S-EAS) of the communication network due to a predicted movement of the UE from a current location to a predicted location within a coverage region of the T-EAS; and
in response to obtaining information that the UE is no longer expected to move to the predicted location within the coverage region of the T-EAS, performing at least one clean-up operation.

13. A network entity for an application context relocation (ACR) procedure of user equipment (UE) in a communication network, wherein the network entity is configured to:
generate an ACR expiration time or an ACR validity time interval for an application context of the UE, wherein:
due to a predicted movement of the UE from a current location within a coverage region of a source edge application server (S-EAS) of the communication network to a predicted location within a coverage region of a target edge application server (T-EAS) of the communication network, the application context of the UE is transferred from the S-EAS to the T-EAS;
provide the ACR expiration time or the ACR validity time interval to the T-EAS or a target edge enabler server (T-EES) of the communication network associated with the T-EAS.

14. The network entity of claim 13, wherein the network entity is further configured to initiate the ACR procedure.

15. The network entity of claim 13 wherein the network entity is further configured to determine the predicted location of the UE.

16. The network entity of claim 13, wherein the network entity is the UE, a source edge enabler server (S-EES), or the S-EAS of the communication network.

17. The network entity of claim 13, wherein the network entity is configured to generate the ACR expiration time or the ACR validity time interval for the application context of the UE based on at least one of a velocity of the UE, a movement direction of the UE, a movement pattern of the UE, a route of the UE, or a motion prediction accuracy of the UE.

18. A method of operating a network entity for supporting an application context relocation (ACR) procedure of user equipment (UE) in a communication network, wherein the method comprises:
generating an ACR expiration time or an ACR validity time interval for an application context of the UE, wherein due to a predicted movement of the UE from a current location within a coverage region of a source edge application server (S-EAS) of the communication network to a predicted location within a coverage region of a target edge application server (T-EAS) of the communication network the application context of the UE is transferred from the S-EAS to the T-EAS; and
providing the ACR expiration time or the ACR validity time interval to the T-EAS or a target edge enabler server (T-EES) of the communication network associated with the T-EAS.
